(19) United States
(12) Patent Application Publication
(10) Pub. No.: US 2010/0313772 A1
(43) Pub. Date: Dec. 16, 2010

(54) PRESSURE-FEEDBACK-TYPE SQUEEGEE MODULE

(76) Inventors: Kuan-Chih LIU, Fengshan City (TW); Kuo-Kai HUNG, Tainan City (TW)

Correspondence Address: Muncy, Geissler, Olds & Lowe, PLLC, 4000 Legato Road, Suite 310, FAIRFAX, VA, 22033, US

(21) Appl. No.: 12/786,146

(22) Filed: May 24, 2010

(30) Foreign Application Priority Data
Jun. 16, 2009 (TW) 098120087

(51) Int. Cl. B05C 17/04

(52) U.S. Cl. 101/123

(57) ABSTRACT

A pressure-feedback-type squeegee module is provided, which includes a squeegee seat having a squeegee to contact a screen mesh of a screen, a pressurization part connecting to the squeegee seat to exert pressure on the squeegee seat, and at least two pressure induction modules configured at two sides of the squeegee seat to induce at least two pressure values transmitted when the squeegee contacts and depresses the screen mesh and to output the pressure values to a pressure control module. Based upon the received pressure values, the pressure control module will compute a proper way to adjust the pressurization part, so as to control depression pressure and pressure direction that the pressurization part acts on the squeegee seat.

### CLAIM FOR PRIORITY

This application claims the benefit of Taiwan Patent Application No. 098120087, filed on Jun. 16, 2009, which is hereby incorporated by reference for all purposes as if fully set forth herein.

### BACKGROUND OF THE INVENTION

1. Field of the Invention

The present invention relates to a squeegee module, and more particularly to a pressure-feedback-type squeegee module which induces depression pressure of a squeegee when the squeegee contacts and depresses a screen mesh so as to adjust the squeegee pressure based upon the induced depression pressure.

2. Description of the Prior Art

The conventional squeegee module is configured in a printing machine to perform a squeegeeing operation to a rigid or flexible substrate, such as a flexible circuit board, a tape or a film. For example, if the flexible circuit board is to be printed with a wiring pattern or solder paste, or is to be coated with a different material such as paste, then the squeegee module can be used to apply the solder paste or paste on the circuit board through a screen. Or, after the printing machine uses a printing head to print conductive ink through a screen on the flexible substrate such as a flexible circuit board, a tape, a film, or similar materials the squeegee module can scrape out excessive ink from the aforementioned flexible substrate.

However, in the conventional printing operation, when a large area screen printing is performed, the coating thickness of the solder paste or adhesive is often non-uniform in some local areas due to a deviation of flatness and lack of a depth displacement pressure detection and compensation design for squeegees. Because the coating thicknesses of the local areas are unable to conform to the specification, a poor contact problem for the circuit pattern of the printed circuit board and the electronic components mounted therein may occur. Besides, due to tolerances of equipment and circuit board thickness, a printing surface may have an error of more than 20 μm. Or, when the squeegee module is scraping excess ink from the screen during a screen printing process, the ink thickness may be non-uniform in some local areas due to a poor depression. Because the coating thicknesses of the local areas are unable to conform to the specification, lines and patterns printed will not meet the requirements.

Accordingly, how to effectively provide a squeegee module which is able to effectively control the squeegee pressure when the squeegee contacts an object, so as to obtain the required lines and patterns on the circuit boards.

### SUMMARY OF THE INVENTION

The present invention is direct to a squeegee module which can induce a depression pressure of a squeegee when the squeegee contacts and depresses the screen mesh of a screen, so as to adjust direction and depression pressure for the squeegee.

The present invention discloses a pressure-feedback-type squeegee module which includes a squeegee seat, a pressurization part, at least two pressure induction modules and a pressure control module.

In one embodiment, a squeegee is disposed in the bottom end of the squeegee seat. The pressurization part is disposed at a center or two sides of a top end of the squeegee seat to exert pressure on the squeegee seat, such that the squeegee contacts and depresses the screen mesh of a screen (i.e. silkscreen). The pressure induction modules are respectively configured at two sides of the squeegee seat, and each pressure induction module is used to induce a pressure value transmitted back when the squeegee contacts and depresses the screen mesh and outputs a signal corresponding to the pressure value to the pressure control module. After receiving the signal corresponding to the pressure value outputted by each pressure induction module, the pressure control module controls the pressurization part based upon the signals, allowing the pressurization part to adjust depression pressure of the squeegee seat; therefore, the squeegee of the squeegee seat can contact and depress the screen mesh with an uniform pressure, so that each pressure value can be substantially the same.

For the pressure-feedback-type squeegee module disclosed by the present invention, the pressure control module uses a plurality of pressure induction modules to induce a plurality of pressure values when the squeegee contacts and depresses a screen mesh. Based upon the plurality of pressure values, the pressure control module can calculate an appreciate depression pressure, so as to adjust of the pressure that the pressurization part acts on the squeegee seat; therefore, a coating thickness can be evenly distributed for any objects with different area sizes, and the error can be reduced to achieve a better printing quality. Also, it can prevent scratch problems caused by the squeegee due to over depression.

To enable a further understanding of the objectives and the technological methods of the invention herein, the brief description of the drawings below is followed by the detailed description of the preferred embodiments

### BRIEF DESCRIPTION OF THE DRAWINGS

FIG. 1 shows a schematic view of a first type structure of squeegee module, according to an embodiment of the present invention.

FIG. 2 shows a schematic view of a pressure control module of an embodiment of the present invention.

FIG. 3 shows a side view of FIG. 1 cutting from a first cutting line C1 , according to an embodiment of the present invention.

FIG. 4 shows a side view of FIG. 1 cutting from a second cutting line C2 according to an embodiment of the present invention.

FIG. 5 shows variation curves of two pressure values of an embodiment of the present invention

FIG. 6 shows variation curves of two pressure values during correction according to an embodiment of the present invention.

FIG. 7 shows variation curves of two pressure values after correction according to an embodiment of the present invention.

FIG. 8 shows a schematic view of a second type structure of squeegee module according to an embodiment of the present invention.

FIG. 9 shows a schematic view of a third type structure of squeegee module according to an embodiment of the present invention.

FIG. 10 shows a schematic view of a fourth type structure of squeegee module according to an embodiment of the present invention.

### DETAILED DESCRIPTION OF THE PREFERRED EMBODIMENTS

The features and practices of the present invention will be illustrated in detail in the following preferred embodiments with reference to the accompanying drawings.

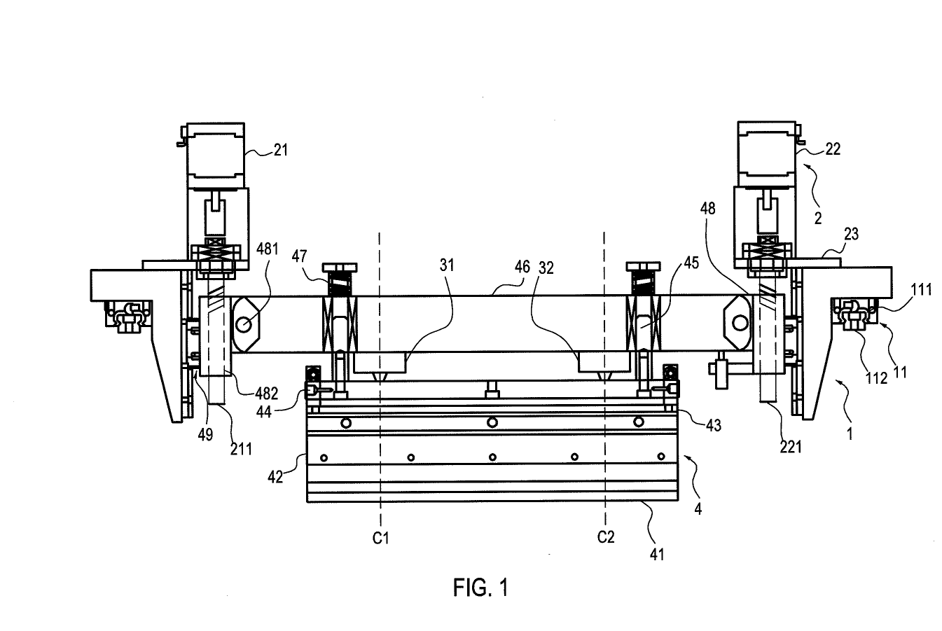

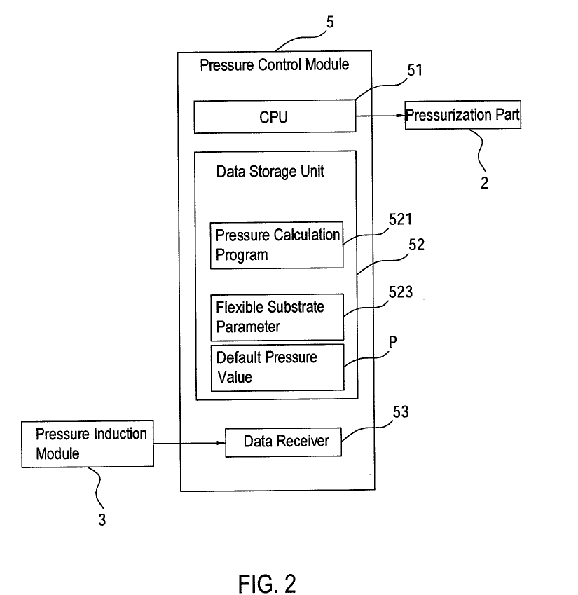

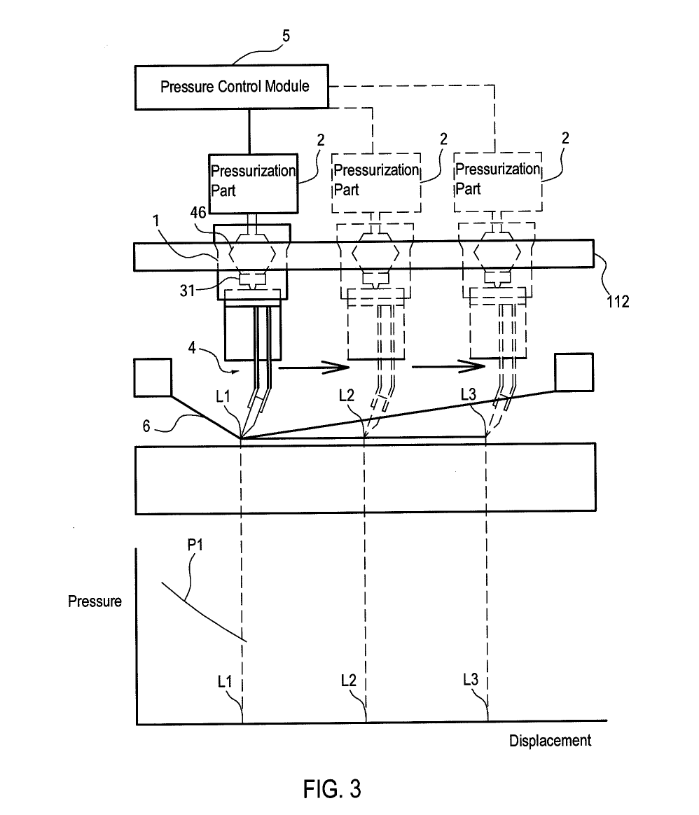

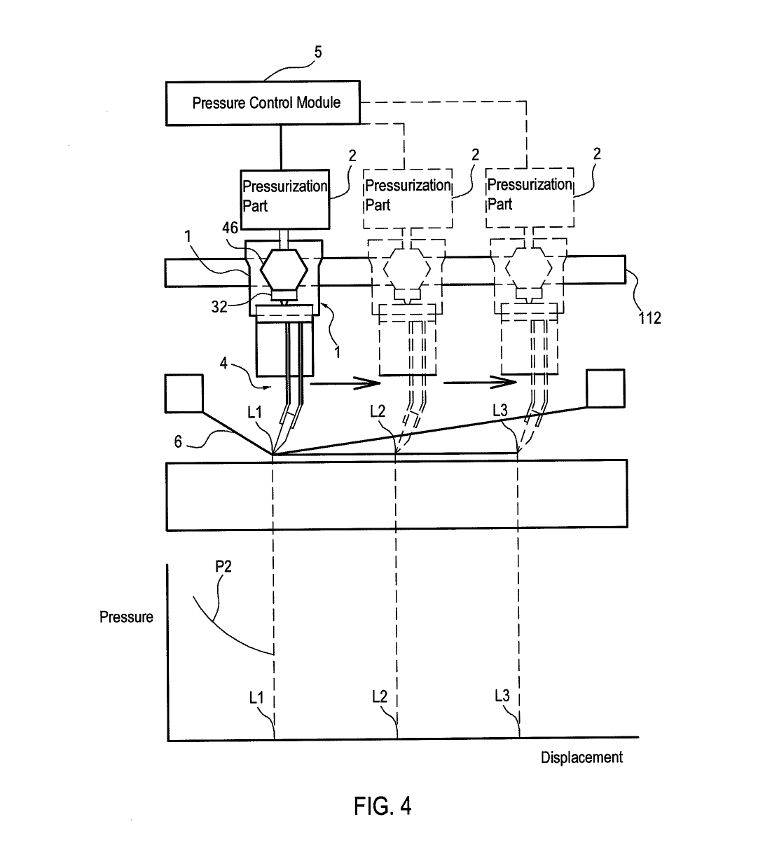

Referring to FIGS. 1 to 4 at the same time, FIG. 1 shows a schematic view of a first type structure of squeegee module according to an embodiment of the present invention; FIG. 2 shows a schematic view of a pressure control module of an embodiment of the present invention; FIG. 3 shows a side view of FIG. 1 cutting from a first cutting line C1 according to an embodiment of the present invention; and FIG. 4 shows a side view of FIG. 1 cutting from a second cutting line C2 according to an embodiment of the present invention. In the embodiment, the squeegee module comprises a sliding rack 1, a pressurization part 2, a pressure induction module 3, a pressure control module 5 and a squeegee seat 4.

The bottom end of the squeegee seat 4 is disposed with a squeegee 41. The squeegee 41 is used to contact and depress a screen mesh 6 of a screen such as silkscreen. This squeegee 41 is connected to a fixing rack 43 of the squeegee seat 4 by a combining assembly 42, and in one embodiment, the squeegee 41 is locked on the fixing rack 43 by latching means. In addition, a squeegee angle adjuster 44 is disposed on two sides of the fixing rack 43 respectively, such that the included angle of the squeegee 41 can be adjusted.

Two ends of the top of the squeegee seat 4, close to the squeegee angle adjusters 44, are disposed symmetrically with two linear bearings 45 for connecting a transversal support bar 46 therethrough. Two linear bearings 45 are disposed with a pre-pressurized spring 47 respectively to physically eliminate backlash between the transversal support bar 46 and the pressure induction modules 3.

Two ends of the transversal support bar 46 are disposed with a bridge module 48 respectively, and in one embodiment, each bridge module 48 is connected to the transversal support bar 46 through a hinge 481 or a latch. The center of each bridge module 48 is transfixed with a vertical screw-hole 482 which is configured at an opposite side of the hinge 481. In the two sides of the squeegee module, a pair of ascending sliding structures 49 is configured between the screw-hole 482 and the sliding rack 1, respectively.

In one embodiment, the pressurization parts 2 are described with two servo transmission modules. A first servo transmission module includes a first servo motor 21 and a first screw 211, whereas a second servo transmission module includes a second servo motor 22 and a second screw 221. The first screw and the second screw are respectively extended outward from the axis of the first servo motor and the second servo motor, and are controlled by the servo motors to rotate; in addition, the first screw 211 and the second screw 221 are screwed respectively into the vertical screw-hole 482 at a relative location. Furthermore, the first servo transmission module and the second servo transmission module further include a support structure 23 respectively, allowing the first servo motor 21 and the second servo motor 22 to be fixed on the sliding rack 1 of the screen printing equipment. It is described here that each sliding rack 1 includes a squeegee sliding mechanism 11 composed by a slide block 111 and a slide rail 112 to define a sliding direction of the squeegee seat 4. On the other hand, two servo motors 21, 22 respectively control the first screw 211 and the second screw 221 to drive the transversal support bar 46 to move, such that the squeegee seat 4 can be driven by the transversal support bar 46 to rotate along a horizontal axis (angular displacement) and ascend or descend along a vertical axis.

In one embodiment, the pressure induction modules 3 are described with two load cells. A first load cell 31 and a second load cell 32 are located between the transversal support bar 46 and the fixing rack 43, close to the linear bearings 45 and provided between the fixing rack 43 and the transversal support bar 46; and each load cell is connected to the pressure control module 5. When the squeegee 41 contacts and depresses the screen mesh 6, the pressure sustained by the squeegee 41 will be fed back to the fixing rack 43. That is to say, the reaction force when the squeegee 41 contacts and depresses the screen mesh 6 will be transmitted to the fixing rack 43, allowing the fixing rack 43 to compress toward the transversal support bar 46. Based upon the compression force between the fixing rack 43 and the transversal support bar 46, the first load cell 31 and the second load cell 32 induce depression pressures that two ends of the squeegee 41 contact and depress the screen mesh 6, so as to produce a first pressure value P1 and a second pressure value P2 and transmit signals corresponding to the first pressure value P1 and the second pressure value P2 to the pressure control module 5. It is described here that the pressure induction modules 3 are not limited to load cells and can be a capacitance type pressure inductor or a resistance type pressure inductor, as well.

The pressure control module 5 includes a central processing unit (CPU) 51, a data storage unit 52 and a data receiver 53. The data storage unit 52 records a pressure calculation program 521, SCREEN parameters 523 (including such as size of the screen mesh 6, sustained pressure and tension of the screen mesh 6, and a distance between the screen mesh 6 and the circuit board), and a default pressure value P with which the squeegee 41 is drawn across a different screen mesh 6. The data receiver 53 will access the signals corresponding to the first pressure value P1 and the second pressure value P2 transmitted by the first load cell 31 and the second load cell 32; the central processing unit 51 will read the aforementioned SCREEN parameters 523 and default pressure value P, in association with the accessed signals corresponding to the two pressure values P1, P2, and use the pressure calculation program 521 to compute a first adjustment value and a second adjustment value. This pressure control module 5 will transmit the first adjustment value to the first servo motor 21 and the second adjustment value to the second servo motor 22, allowing the first servo motor 21 and the second servo motor 22 to control the screws 211, 221, based upon the first adjustment value and the second adjustment value, to drive the transversal support bar 46 to move vertically (linear displacement) and/or rotate horizontally (angular displacement), thereby changing squeegee pressure and pressure direction that the squeegee 41 applies to the screen mesh 6.

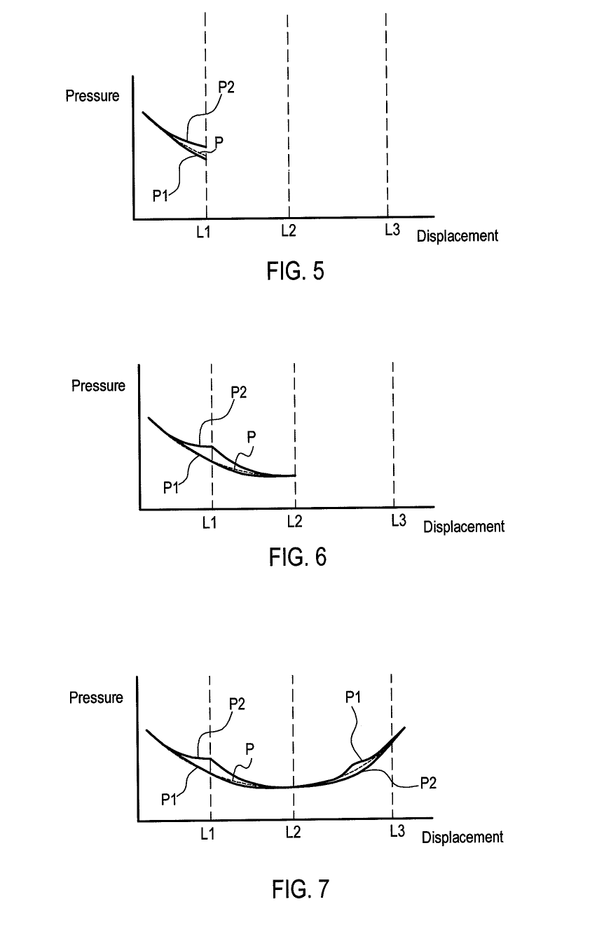

Referring to FIGS. 1, 3, 4, 5, 6 and 7, FIG. 5 shows variation curves of two pressure values of an embodiment of the present invention; FIG. 6 shows variation curves of two pressure values during correction according to an embodiment of the present invention; and FIG. 7 shows variation curves of two pressure values after correction according to an embodiment of the present invention.

As shown in FIG. 3 and FIG. 4, when the squeegee seat 4 is driven to slide to a first position L1, the first load cell 31 induces the first pressure value P1 and the second load cell 32 induces the second pressure value P2. As shown in FIG. 5, when the squeegee seat 4 is located at the first position L1, neither the first pressure value P1 nor the second pressure value P2 complies with the default pressure value P. As a result, the pressure control module 5 will output respectively the first adjustment value and the second adjustment value to the first servo motor 21 and the second servo motor 22, allowing the first servo motor 21 and the second servo motor 22 to adjust depression pressure and pressure direction acted on the squeegee seat 4, based upon the first adjustment value and the second adjustment value.

Regarding to FIG. 5, when the squeegee seat 4 is at the first position L1, the first servo motor 21 exerts less pressure on the squeegee seat 4; therefore, the pressure control module 5 lets the first servo motor 21 rotate the first screw 211 to drive the bridge module which is connected with the first screw 211 downward, thereby improving vertical pressure acted on the transversal support bar 46. On the other hand, the second servo motor 22 exerts over pressure on the squeegee seat 4; therefore, the pressure control module 5 lets the second servo motor 22 rotate the second screw 221 to drive the bridge module 48 which is connected with the second screw 221 upward, thereby reducing vertical pressure acted on the transversal support bar 46. Accordingly, by this method, the squeegee seat 4 is controlled to rotate along the horizontal axis and ascend or descend along the vertical axis. At the same time, the squeegee 41 can uniformly contact the screen mesh 6. The pressure curves after correction are shown in FIG. 6. During the period when the squeegee seat 4 moves from the first position L1 to a second position L2, the pressure control module 5 will keep adjusting pressure that the first servo motor 21 and the second servo motor 22 act on the squeegee seat 4; whereas, the first pressure value P1 and the second pressure value P2 that the two load cells induce will be corrected toward the default pressure value P to be physically identical to the default pressure value P.

Please referring to FIG. 6 and FIG. 7 at the same time, when the squeegee seat 4 starts to move from the second position L2 to a third position L3, the first servo motor 21 exert over pressure on the squeegee seat 4; therefore, the pressure control module 5 lets the first servo motor 21 rotate the first screw 211 to drive the bridge module 48 which is connected with the first screw 211 upward, thereby reducing vertical pressure acted on the transversal support bar 46. On the other hand, the second servo motor 22 exert less pressure on the squeegee seat 4; therefore, the pressure control module 5 lets the second servo motor 22 rotate the second screw 221 to drive the bridge module 48 which is connected with the second screw 221 downward, thereby improving vertical pressure acted on the transversal support bar 46.

The pressure curves after correction are also shown in FIG. 7. Before the squeegee seat 4 reaches to the third position L3, the pressure control module 5 will keep adjusting pressure that the first servo motor 21 and the second servo motor 22 act on the squeegee seat 4; whereas, the first pressure values P1 and the second pressure value P2 that the load cells induce will be corrected toward the default pressure value P, so that the pressure values P1, P2 are physically identical to the default pressure value P.

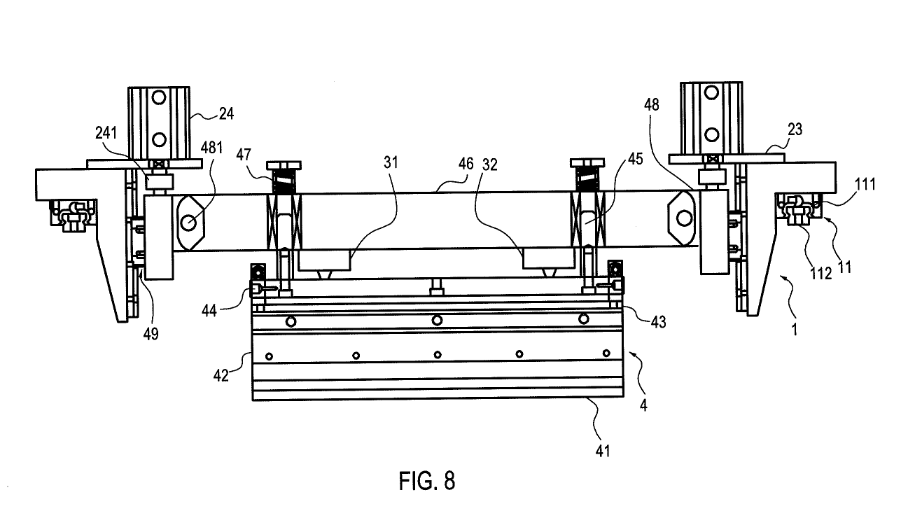

Referring to FIG. 8, it shows a schematic view of a second type structure of squeegee module according to an embodiment of the present invention. A difference between the second type structure and the first type structure in FIG. 1) lies in that two pneumatic cylinders 24 are used to replace the first servo motor 21 and the second servo motor 22, and each pneumatic cylinder 24 is provided with a connector 241 to connect with the corresponding bridge module 48.

The signals corresponding to the first pressure value P1 and the second pressure value P2 induced by the first load cell 31 and the second load cell 32 will be transmitted to the pressure control module 5 which computes two adjustment values corresponding to the two pneumatic cylinders 24 and transmits the adjustment values respectively to the two pneumatic cylinders 24. Each pneumatic cylinder 24 will drive the connected bridge module 48, based upon the received adjustment value, to ascend or descend, thereby controlling the squeegee seat 4 to rotate along the horizontal axis and ascend or descend along the vertical axis, as well as allowing the squeegee 41 to uniformly contact the screen mesh 6.

However, in addition to the servo motors and pneumatic cylinders 24, a pressure device can be further configured and designed with an electric cylinder or a hydraulic cylinder without limitation, as long as the equipment is provided with a valve control function and can drive the transversal support bar 46 to ascend or descend.

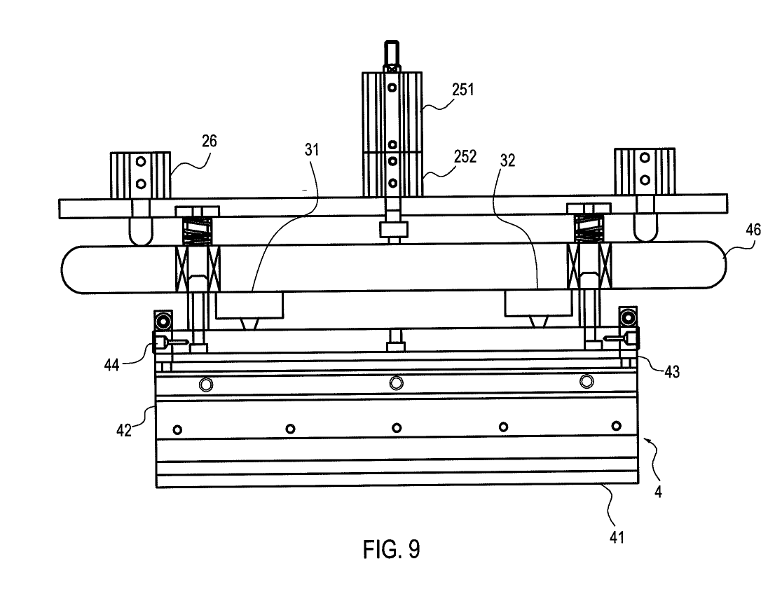

Referring to FIG. 9, it shows a schematic view of a third type structure of squeegee module according to an embodiment of the present invention. A difference between the third type structure and the first and second type structures in FIG. 1 and FIG. 2 lies in that the top position of the squeegee module is further connected with a vertical pressure device configured in the screen printing equipment. In one embodiment, the vertical pressure device includes a vertical pressure cylinder 251 and a vertical constant pressure cylinder 252. The vertical pressure cylinder 251 is used to control ascending and descending of the squeegee seat 4 and the vertical constant pressure cylinder 252 is used to keep pressure provided by the vertical pressure cylinder 251 at a constant value, to maintain a height of the squeegee seat 4. Besides, two ends of the transversal support bar 46 are connected with a horizontal pressure device respectively. In one embodiment, the horizontal pressure device is described with a horizontal constant pressure cylinder.

The signals corresponding to the first pressure value P1 and the second pressure value P2 induced by the first load cell 31 and the second load cell 32 will be transmitted to the pressure control module 5 which computes two adjustment values corresponding to two horizontal constant pressure cylinders 26 and transmits the two adjustment values to the two horizontal constant pressure cylinders 26 respectively, as well as computes a vertical adjustment value corresponding to the vertical pressure cylinder 251 and transmits the vertical adjustment value to the vertical pressure cylinder 251.

Based upon the received adjustment value, each horizontal constant pressure cylinder 26 will drive the part that connects with the transversal support bar 46, allowing the transversal support bar 46 to ascend, descend, or shift along a horizontal axis, thereby driving the squeegee seat 4 to rotate along a horizontal axis. On the other hand, based upon the vertical adjustment value, the vertical pressure cylinder 251 controls the transversal support bar 46 to move along a vertical axis, thereby driving the squeegee module to ascend or descend along a vertical axis. In addition, using the vertical constant pressure cylinder 252 to keep at final pressure exerted by the vertical pressure cylinder 251, the squeegee seat 4 is maintained at a specific height. Accordingly, by this method, the squeegee seat 4 is controlled to rotate along a horizontal axis and ascend or descend along a vertical axis; at the same time, the squeegee 41 can uniformly contact the screen mesh 6.

It is described here that, in addition to selecting the pneumatic cylinder 24 for the vertical pressure device and the horizontal pressure device, an electric cylinder, a hydraulic cylinder or a servo motor can be used, as well.

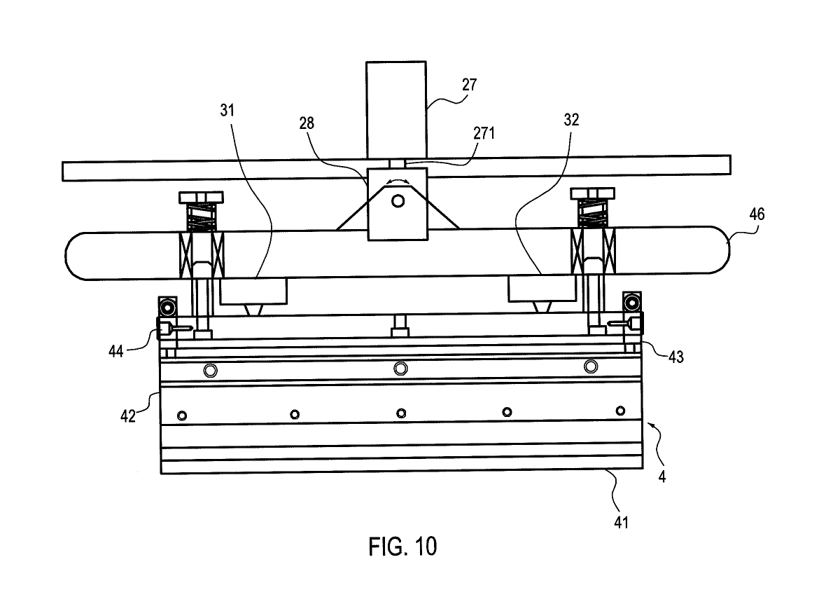

Referring to FIG. 10, it shows a schematic view of a fourth type structure of squeegee module according to an embodiment of the present invention. A difference between the fourth type structure and the previous three type structures lies in that two ends of the transversal support bar 46 are not configured with any pressure equipment.

The pressurization part 2 is composed by a vertical pressure device and a rotational balance motor 28. In one embodiment, the vertical pressure device is described with, but not limited to, a vertical electric cylinder 27; the vertical pressure device can be also a pneumatic cylinder, a hydraulic cylinder or a servo motor.

In one embodiment, the vertical electric cylinder 27 is extended with a moment arm 271, one end of the moment arm 271 is configured with the aforementioned rotational balance motor 28, and the rotational balance motor 28 is further connected to a center part of the transversal support bar 46.

The signals corresponding to the first pressure value P1 and the second pressure value P2 induced by the first load cell 31 and the second load cell P2 will be transmitted to the pressure control module 5 which computes a horizontal rotation adjustment value corresponding to the rotational balance motor 28 and transmits the horizontal rotation adjustment value to the rotational balance motor 28, as well as computes a vertical adjustment value corresponding to the vertical electric cylinder 27 and transmits the vertical adjustment value to the vertical electric cylinder 27.

Based upon the received horizontal rotation adjustment value, the rotational balance motor 28 will drive the part that connects with the transversal support bar 46, allowing the transversal support bar 46 to rotate along a horizontal axis, thereby driving the squeegee seat 4 to rotate along a horizontal axis. On the other hand, based upon the vertical adjustment value, the vertical electric cylinder 27 will drive the squeegee module to ascend or descend along a vertical axis, and keep the squeegee seat 4 at a specific height by collaborating with the rotational balance motor 28 to adjust an angle of the transversal support bar 46. Accordingly, by this method, the squeegee seat 4 is controlled to rotate along the horizontal axis and ascend or descend along the vertical axis; at the same time, the squeegee 41 can uniformly contact the screen mesh 6.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A pressure-feedback-type squeegee module, which is applied in screen printing equipment to perform a squeegeeing operation with a screen mesh, comprising:
a squeegee seat, a bottom thereof is disposed with a squeegee being used to contact a screen mesh of a screen;
a pressurization part which is connected to the squeegee seat and is used to exert pressure on the squeegee seat;
at least two pressure induction modules which are configured at two sides of the squeegee seat to induce at least two pressure values transmitted when the squeegee contacts and depresses the screen mesh, and to output signals corresponding to the pressure values; and
a pressure control module which accesses the signals corresponding to the pressure values outputted by at least two pressure induction modules and controls the pressurization part to exert pressure on the squeegee seat, based upon the signals.

2. The pressure-feedback-type squeegee module according to claim 1, wherein the pressure induction modules are a capacitance type pressure inductor, a resistance type pressure inductor or a load cell.

3. The pressure-feedback-type squeegee module according to claim 1, wherein the pressure control module further stores at least one default pressure value and compares the pressure values with the default pressure value respectively.

4. The pressure-feedback-type squeegee module according to claim 1, wherein the pressurization part includes two pressure devices, the squeegee seat includes a transversal support bar, the pressure devices are configured respectively at two ends of the transversal support bar and the pressure control module controls the pressure devices respectively, in order to adjust vertical pressure that the pressure devices act on two ends of the transversal support bar.

5. The pressure-feedback-type squeegee module according to claim 4, wherein pressure that the pressure devices act on the squeegee seat allows the squeegee seat to rotate along a horizontal axis.

6. The pressure-feedback-type squeegee module according to claim 4, wherein pressure that the pressure devices act on the squeegee seat allows the squeegee seat to move along a vertical axis.

7. The pressure-feedback-type squeegee module according to claim 4, wherein the pressure devices are an electric cylinder, a pneumatic cylinder, a hydraulic cylinder or a servo motor.

8. The pressure-feedback-type squeegee module according to claim 1, wherein the pressurization part includes a vertical pressure device and a rotational balance motor, the squeegee seat includes a transversal support bar, the vertical pressure device is extended with a moment arm, the rotational balance motor is configured at an end of the moment arm to connect with the transversal support bar, the pressure control module controls vertical pressure that the vertical pressure device acts on the transversal support bar and controls an angle of the transversal support bar which is adjusted by the rotational balance motor.

9. The pressure-feedback-type squeegee module according to claim 8, wherein the vertical pressure device is an electric cylinder, a pneumatic cylinder, a hydraulic cylinder or a servo motor.

10. The pressure-feedback-type squeegee module according to claim 1, wherein the pressurization part includes two horizontal pressure devices and a vertical pressure device, the squeegee seat includes a transversal support bar, the horizontal pressure devices are connected respectively at two ends of the transversal support bar, the vertical pressure device is connected at the transversal support bar and is located between the horizontal pressure devices, and the pressure control module controls respectively the horizontal pressure devices and the vertical pressure device, allowing the transversal support bar to rotate along a horizontal axis and to move along a vertical axis.

11. The pressure-feedback-type squeegee module according to claim 10, wherein the horizontal pressure devices are an electric cylinder, a pneumatic cylinder, a hydraulic cylinder or a servo motor.

12. The pressure-feedback-type squeegee module according to claim 10, wherein the vertical pressure device is an electric cylinder, a pneumatic cylinder, a hydraulic cylinder or a servo motor.
